(19) United States
(12) Patent Application Publication
(10) Pub. No.: US 2013/0154380 A1
(43) Pub. Date: Jun. 20, 2013

(54) Method for Controlling Individual Photovoltaic Modules of a Photovoltaic System

(71) Applicant: Newtos AG, Baech (CH)

(72) Inventor: Bernd Willer, Moosburg (DE)

(73) Assignee: Newtos AG, Baech (CH)

(21) Appl. No.: 13/757,115

(22) Filed: Feb. 1, 2013

Related U.S. Application Data
(63) Continuation of application No. PCT/DE2011/075176, filed on Jul. 25, 2011.

(30) Foreign Application Priority Data
Aug. 3, 2010 (DE) 10 2010 036 816.4

(51) Int. Cl. H02J 1/00

(52) U.S. Cl. CPC H02J 1/00
USPC 307/77

(57) ABSTRACT

A method for switching photovoltaic (PV) modules in a PV system to a safe state in the case of a hazard is described. Control units, each one associated with a corresponding one PV module, measure the voltage profile and/or the current of each associated PV module. Should the voltage of a PV module increase from the operating voltage to the idle voltage or, conversely, drop from the idle voltage to the operating voltage, or the current in the phase fall below a reference value, then the control unit associated with the PV module is activated. When activated, the PV module is either isolated from the phase on at least one connection side, with the result of at least one isolation location having a capacitor remaining connected in parallel with it, or a low-impedance load is connected in parallel to the PV module in a clocked fashion.

### BACKGROUND INFORMATION

1. Field of the Invention

The invention relates to a method of switching the photovoltaic modules of a photovoltaic system to a safe state in the event of a hazardous situation or during service work, without the PV modules or the inverter becoming damaged. More particularly, the invention relates to using control devices to switch the PV modules to a state that is safe for humans.

2. Discussion of the Prior Art

Devices are already known that allow PV systems to be automatically switched to states that are not hazardous to people.

German patent DE 10 2005 017 835 B3 discloses a photovoltaic generator that has a thermal switch that is actuated by a temperature increase and that short-circuits the PV modules.

The photovoltaic generator has the drawback, however, that the thermal switch is only triggered if the temperature increase is in the immediate vicinity of the generator and opens again as soon as the temperature drops. These situations may not, however, always occur, as in the case of a fire, and when water is used to douse the fire. It is not apparent on the exterior of the PV module, i.e., by looking at the module, whether it has been de-energized. Furthermore, the system cannot be de-energized manually.

German patent DE 10 2008 052 037 B3 describes a solar module, on which a number of solar cells can be bypassed in a low-impedance manner by means of external pressure control lines and mechanical pressure activators.

The external pressure control lines and mechanical pressure actuators are, however, relatively susceptible to damage as a result of the moving parts. In addition, the PV modules are statically short-circuited in a solar module, whereby the individual PV modules and the inverter can become damaged. Another drawback is that additional control lines are required, in addition to the wiring provided for the solar system.

The prior art also discloses WO 2007.1048421 A2 and DE 10 2008 008 505 A1, as well as DE 10 2007 048 914 A1, which relate to control devices for controlling photovoltaic systems.

### BRIEF SUMMARY OF THE INVENTION

It is the object of the invention to provide a method of switching photovoltaic (PV) modules of a PV system to a safe state in the event of a hazardous situation, such as, for example, a fire, without damaging the PV modules or the inverter. It is a further object to provide a control device to implement the method, the control device being able to be operated exclusively with the existing wiring of the PV system.

The PV system comprises a plurality of PV modules that form at least one PV string and, according to the invention, a separate control unit is associated with each PV module, in order to control the individual PV modules in the particular string. If the PV system includes a plurality of PV strings, the PV modules in each string are controlled. Each control unit monitors the voltage curve and/or the current of its associated PV module.

If the voltage curve is monitored and an increase from the operating voltage to the open-circuit voltage in the PV module voltage is detected, or, alternatively, if the voltage decreases from the open-circuit voltage to the operating voltage, the control unit of the respective PV module is activated, i.e., the control unit triggers a specified action, discussed below. The control unit is only activated when a voltage increase or voltage drop on the PV module exceeds a specified critical value for a defined time period, in order to ensure that short-term, non-hazardous voltage peaks or voltage drops do not cause the control unit to be activated.

If a control unit monitors the current through the PV module, the control unit is activated as soon as the current drops below a reference value, for example, 100 mA.

The method according to the invention includes two control variants. In a first variant, when the control unit is activated, at least one terminal end of the PV module is disconnected from the associated string. A capacitor remains connected in parallel to the resulting at least one disconnection point, that is, the PV modules remain connected to each other via the capacitors even after being disconnected from the string. While this suppresses direct currents from flowing through the string, alternating currents and pulse-shaped direct current signals continue to flow.

In a second variant, a low-impedance load is connected in parallel to the PV module in a clocked manner, that is, the low-impedance load is alternately connected in parallel to the PV module for a particular time and then disconnected therefrom. As a result of the clocked parallel connection, the effective voltage of the PV module averaged over time decreases.

The clocking is varied while the low-impedance load is being connected, such that the average value of the time during which the load is connected in parallel to the PV module steadily increases and ultimately reaches a constant value. This is done to prevent the inverter of the PV system or the at least one PV module from becoming damaged by current peaks. When the low-impedance load is disconnected, the average value decreases steadily in corresponding fashion and ultimately goes to zero.

In an advantageous embodiment of the second variant, the clocking is selected such that microcontrollers in the control units are just barely supplied with their minimum allowed operating voltage by the effective voltage, i.e., residual voltage, supplied by the PV module.

If all control units in one string are activated, either in a manner corresponding to the first variant by disconnecting a corresponding PV module from the string, or corresponding to the second variant by a providing a clocked connection in parallel of a low-impedance load, the overall voltage of the at least one string decreases to a value that is not hazardous to humans.

In order to resume operation of the PV system by resetting all activated control units, if a load is connected in parallel in a clocked manner to the PV modules when the control units are activated and during the clocked parallel connection the microcontroller that is associated with the at least one PV module is supplied with at least the minimum operating voltage thereof, then the at least one string is short-circuited for approximately 2 seconds. The operating voltage of the microcontrollers collapses within the 2 seconds and the microcontroller is reset, that is, restarted.

Alternatively, to reset all activated control units of the at least one string, an electric pulse or an electric pulse sequence may be sent through the conductors of the at least one string in the first or second variant, that is, when the PV module is disconnected from the string on at least one side or when the load is connected in parallel in a clocked manner to the at least one PV module and the microcontroller that is associated with the at least one PV module is supplied with its minimum operating voltage. The microcontrollers in the control units are programmed so that they detect the electric pulse or the electric pulse sequence and reset the activated control units.

The control device according to the invention for controlling the PV modules comprises a plurality of control units, as mentioned above, whereby each individual control unit is associated with and connected to a particular PV module. Preferably, each PV module in the PV system is provided with a control unit.

Each of the control units is equipped with: at least one measuring device, which serves to detect the voltage curve of the PV module or the current flowing through the PV module; a microcontroller for monitoring the voltage curve of the PV module or the current flowing through the PV module; and either at least one module isolating switch for disconnecting at least one side of the PV module that is associated with the control unit from the string, or a circuit for connecting a low-impedance load in parallel to the associated PV module in a clocked manner.

The measuring device for detecting the current flowing through the PV module comprises, for example, a low-impedance shunt resistor, connected in series between the PV module containing the associated microcontroller and a neighboring PV module of the same string; an operational amplifier, which is used to determine and amplify the voltage that drops across the shunt resistor and compare the same to voltage reference values; and a temperature compensation circuit, which provides temperature-dependent voltage reference values for the operational amplifier.

For example, the control units, which, when activated, connect a low-impedance load in parallel to the associated PV module in a clocked manner, have, for example, a switch, either electronic or mechanical or constructed as a combination of both, and a low-impedance load resistor for limiting current, whereby the switch and the resistor are connected in series. The series-connected resistor/switch is connected in parallel to the associated PV module.

The control units are usually integrated into the junction boxes of the PV modules, mounted to the junction boxes, or arranged in the immediate vicinity of the junction boxes.

The control units are equipped with LEDs, which light up when the respective control unit is activated. This enables easy recognition of which strings are switched to a safe operating state, i.e., to an overall voltage that is not hazardous to humans.

The control device is cost-effective to produce because it can be manufactured using standard electronic components and because no additional control lines are required, aside from the already existing wiring for the solar system.

The control device can be operated particularly advantageously in conjunction with a monitoring unit for PV systems, the monitoring unit having a power supply part, a current sensor that detects the current flowing through the at least one string, a generator that has a capacity voltage converter as theft protection device, a microcontroller that serves to evaluate the current values supplied by the current sensor and the voltage values supplied by the capacity voltage converter, a decoupling element for decoupling the at least one string at least from the capacitors of the inverter, a reset device for the control units of the control device, an alarm reset device, and a galvanically isolated interface that is used to transmit alarms to an external alarm center.

### BRIEF DESCRIPTION OF THE DRAWINGS

The invention will be described in more detail hereafter based on two exemplary embodiments.

FIG. 1 is a block diagram of a photovoltaic system equipped with a control device and a monitoring device.

FIG. 2 is a block diagram of monitoring device.

FIG. 3 is a block diagram of three control units connected in series, which, when activated, switch the PV modules in a clocked manner.

FIG. 4 is a block diagram of three control units connected in series, which, when activated, disconnect the PV modules from the string.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

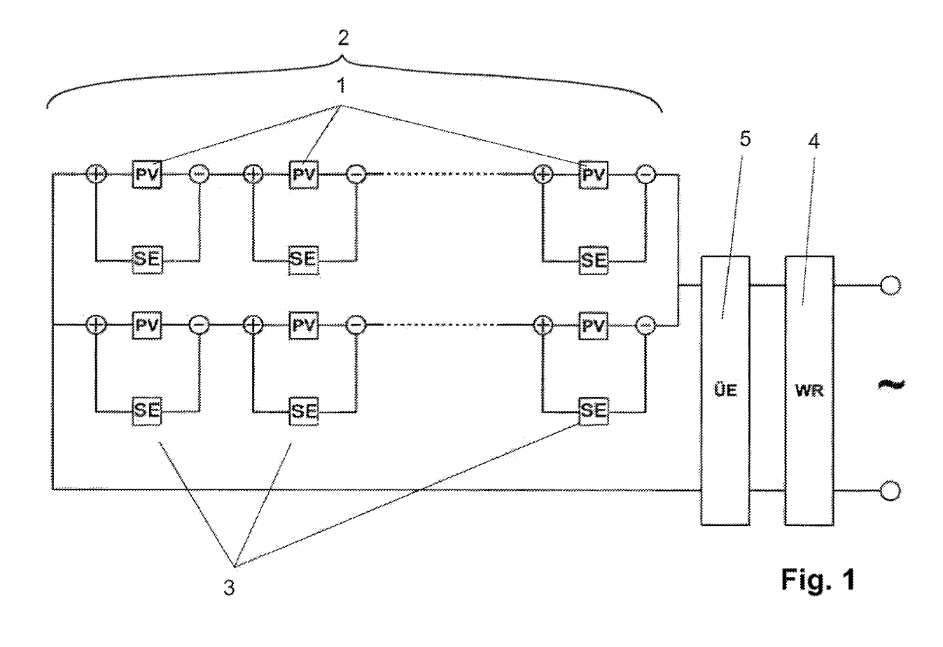

FIG. 1 is a block diagram of a PV system according to the invention comprising a plurality of PV modules 1, a corresponding plurality of control units 3, an inverter 4, and a monitoring device 5. The PV modules 1 are connected in a series-parallel manner to form a string 2, and each of the control units 3 is connected in parallel to a particular PV module 1. The inverter 4 converts the direct current generated by the PV modules into line voltage. The monitoring device 5 is connected between the inverter and string 2 and monitors the PV system with regard to theft and arcing, i.e., voltage spark-overs. The control units 3 together form the control device according to the invention. With regard to the abbreviations in the block diagram, SE is the control unit 3, UE the monitoring device 5, and WR the inverter 4.

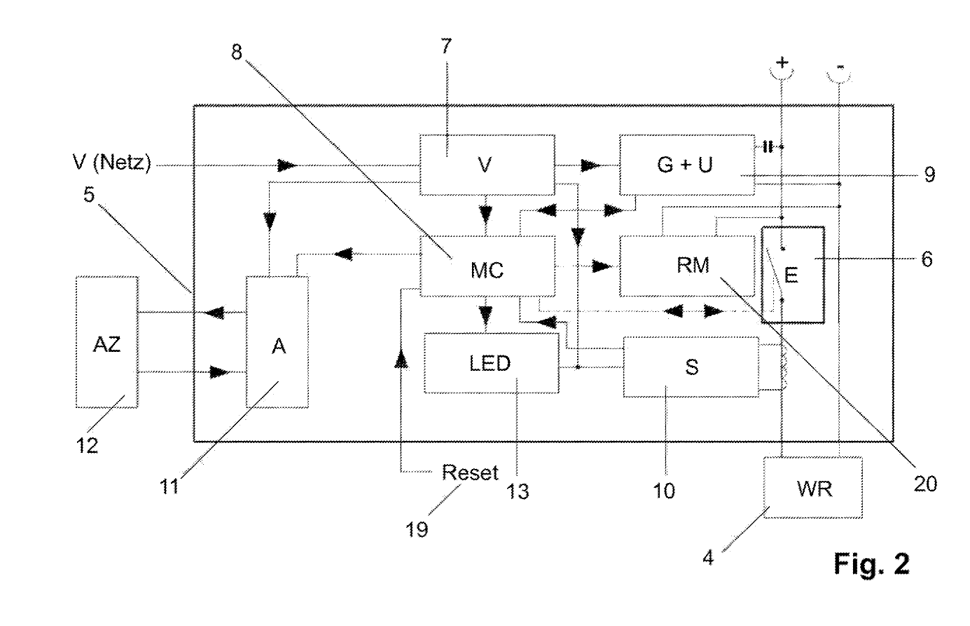

FIG. 2 illustrates the monitoring device 5, which is operated with alternating line current. The conductors of the connected string 2 are connected via a decoupling element 6 to the inverter 4. The decoupling element 6 serves to de-couple the capacitor. A power supply unit 7 converts the alternating line current to low voltage, which supplies a microcontroller 8, a generator with a capacity voltage converter 9, a current sensor 10, and a light-emitting diode 13. The microcontroller 8 detects the output signals of the generator with the capacity/voltage converter 9 and the current sensor 10. If a reverse current or arcing occurs in the connected string 2, the current sensor 10 outputs a characteristic voltage curve, which is detected and recognized by the microcontroller 8 as a malfunction. The microcontroller 8 then opens the decoupling element 6 and/or transmits a signal to an alarm signal interface 11, which forwards the alarm to an alarm center 12. A light-emitting diode 13 indicates the fault on a display of the monitoring device 5. With regard to the abbreviations in the block diagram, WR is the converter 4, E the decoupling element, V the power supply 7, MC the microcontroller 8, G+U the generator with converter 9, S the current sensor 10, A the alarm signal interface 11, AZ the alarm center 12, LED the light-emitting diode 13, and RM a reset 20 for the control units 3.

If an isolating switch is used as the decoupling element 6, the voltage that is generated by the PV modules in the daytime can be monitored, as a theft monitoring device. Thus, if the voltage drops to a defined minimum solar voltage, it is very likely that a PV module 1 has been stolen. If string diodes are used as the decoupling element 6, a square-wave pulse, i.e., a voltage pulse is output to the conductors of the string 2 by the generator with the capacity voltage converter 9 as a means to monitor the PV modules 1 for theft at night, or day and night. The voltage signal that develops as a capacitive response of the string 2 to the square-wave pulse indicates whether one or more PV modules 1 from the string 2 have been removed, or whether manipulations, such as, for example, bypassing PV modules prior to an intended theft, were carried out. The decoupling element 6 serves to disconnect the capacitor, so that the capacitances of the capacitors in the inverter 4 are not included in the measurement.

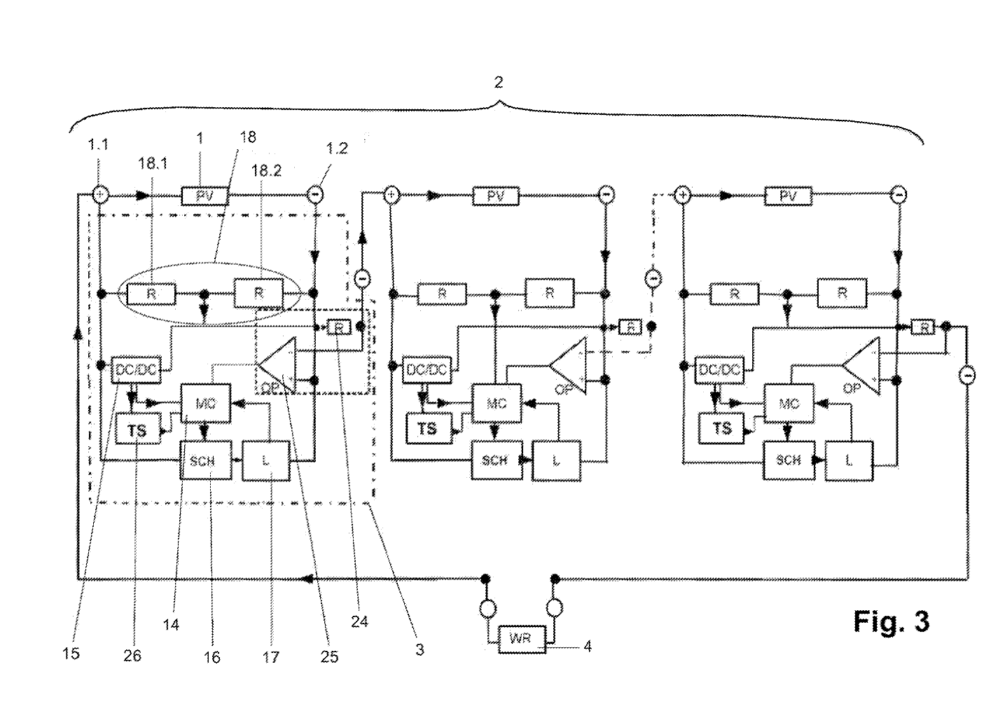

FIG. 3 illustrates details of the PV module string 2. Three PV modules 1 are connected in series, each of which is equipped with a control unit 3. Each control unit 3 detects the current flowing through its corresponding PV module 1 or the voltage of the PV module 1. The control unit 3 that is associated with the first of the three PV modules 1 is framed with a dash-dotted line.

The control unit 3 houses a microcontroller 14, a voltage transformer 15, a switch 16, a load 17, and a voltage divider 18. The voltage transformer 15 supplies voltage to the microcontroller 14. The input voltage to the voltage transformer 15 is supplied via the terminals 1.1 and 1.2 of the PV module 1. The voltage transformer 15 supplies the supply voltage to the microcontroller 14 as long as the voltage on the PV module 1 is greater than the voltage required to operate the microcontroller 14. The microcontroller 14 detects the voltage of the PV module 1 by means of the voltage divider 18, which includes series-connected resistors 18.1 and 18.1. As soon as the voltage detected by the microcontroller 14 exceeds a defined value, the microcontroller 14 sends a signal to the switch 16. The switch 16 then connects a load 17 in parallel to the terminals 1.1 and 1.2 in a clocked manner. Because the load 17 has a very low ohmic resistance, current flow across the load 17 is strong, which results in a drastic decrease in the voltage between the terminals 1.1 and 12.

As soon as the load 17 is connected, the microcontroller 14 also determines the voltage drop across the load 17. Based on the voltage drops across the load 17 and the voltage divider 18, the microcontroller 14 determines a clock rate with which the switch 16 must be switched so that the voltage between the terminals 1.1 and 1.2 does not drop below the minimum required supply voltage of the voltage transformer 15 for the microcontroller 14, i.e., a defined control circuit. This operating state is maintained until the microcontroller 14 is reset and no longer actuates or opens the switch 16.

The current measuring device 3 comprises a low-impedance shunt resistor 24, which is connected in series between the PV module 1 and the neighboring PV module 1 of the same string 2, an operational amplifier 25, which is used to determine and amplify the voltage that drops across the shunt resistor 24 and compare the same to voltage reference values, and a temperature compensation circuit 26, which provides the temperature-dependent voltage reference values for the operational amplifier 25.

With regard to the abbreviations used in the block diagram, SCH refers to the switch 16, L to the load 17, and TS to the temperature compensation circuit 26, and WR to the inverter 4.

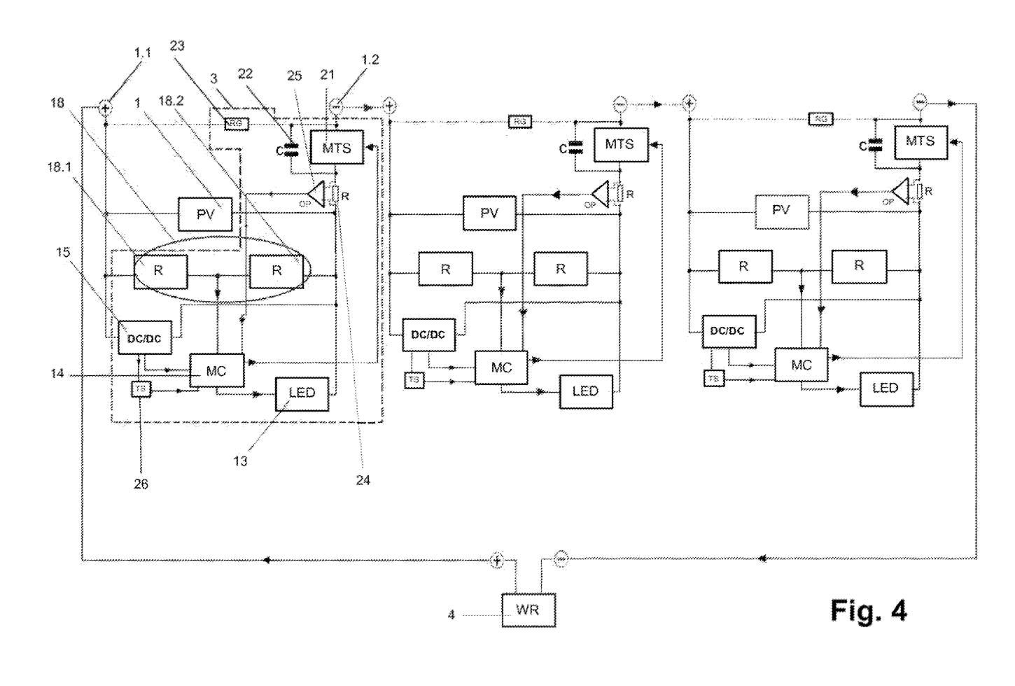

FIG. 4 likewise illustrates three PV modules 1 with control units 3, the PV modules connected in series, whereby the control unit 3 that is associated with the first of the three PV modules 1 is identified by the dot-dash line. In the event of damage or crash, the overall voltage of the string 2 is decreased to a non-hazardous value, for example, below a predetermined threshold value, by electrically disconnecting the individual PV modules 1 from the respective string 2, and not, as in the previous example, by connecting a low-impedance load 17 in parallel in a clocked manner. The individual PV modules 1 are disconnected from each other by a module isolating switch 21, which is constructed as a semiconductor switch or relay. A base load resistor 23 is required to operate a semiconductor switch. A capacitor 22 is connected in parallel to the module isolating switch 21, to allow uncomplicated resetting of the control units 3. The individual PV modules, however, still remain connected to each other when the module isolating switch 21 is open via a capacitor 22 in each module. This allows alternating current signals or pulse sequences to be transmitted to the control units 3 for resetting the control units 3 via the existing PV system wiring.

The abbreviations used in the block diagram FIG. 4 include the following: TS for the temperature compensation switch 26, MTS for the module isolating switch 21, and WR for the inverter 4.

It is understood that the embodiments described herein are merely illustrative of the present invention. Variations in the construction of the PV system and method of operation may be contemplated by one skilled in the art without limiting the intended scope of the invention herein disclosed and as defined by the following claims.

What is claimed is:

1. A method for controlling individual PV modules of a PV system, the method comprising the steps of:
a) providing a PV string that includes a plurality of PV modules;
b) providing a control device that includes a corresponding plurality of control units;
c) associating one control unit with a corresponding one PV module of the plurality of PV modules, wherein each control unit measures the voltage curve and/or the current of the corresponding one PV module;
d) if the voltage of the one PV module increases from an operating voltage to an open-circuit voltage, or the voltage decreases from the open-circuit voltage to the operating voltage, or the current in the string drops below a reference value, activating the control unit of the one PV module, wherein activation of the control unit results in a drop of the overall voltage of the at least one string to a value that is not hazardous to humans.

2. The method of claim 1, step c) further comprising the step of:
d1) selectively disconnecting the PV module from the string on at least one terminal end, wherein a capacitor remains connected in parallel to the resulting at least one disconnection point.

3. The method of claim 1, step c) further comprising the step of:
d2) connecting a low-impedance clocked load in parallel to the PV module.

4. The method of claim 4, further comprising the step of:
e) when energizing the load that is connected in parallel with the at least one PV module, varying the clocking such that the average value of the time during which the load is connected to the PV module increases steadily and ultimately reaches a constant value, and when de-energizing the load, varying the clocking such that the average value decreases steadily and ultimately goes to zero, thereby preventing damage due to current peaks to an inverter of the at least one PV module.

5. The method of claim 4, further comprising the step of:
f) when energizing the load that is connected in parallel to the at least one PV module, selecting the clocking such that a microcontroller present in the control unit that is associated with the at least one PV module is provided a voltage that corresponds to at least the minimum operating voltage of the microcontroller.

6. The method of claim 3, further comprising the step of
g) short-circuiting the at least one string for approximately 2 seconds if, during the activation of the control units, the load is connected in parallel to the PV modules in a clocked manner and the microcontroller (14) that is associated with the at least one PV module is supplied with at least a minimum operating voltage thereof, so as to reset all activated control units of the at least one string.

7. The method of claim 3, further comprising the step of:
h) sending an electric pulse or an electric pulse sequence via the conductors of the at least one string, if the load is connected in parallel to the at least one PV module in a clocked manner and the microcontroller that is associated with the at least one PV module is supplied with at least the minimum operating voltage thereof, so as to reset all activated control units of the at least one string, wherein the microcontroller of a respective control unit that is associated with the at least one PV module detects the electric pulse or the electric pulse sequence and resets the control unit.

8. The method of claim 2 further comprising the step of:
i) sending an electric pulse or an electric pulse sequence via the conductors of the at least one string, if the PV module is disconnected from the string at at least one end, so as to reset all activated control units of the at least one string, wherein the microcontroller of a respective control unit that is associated with the at least one PV module detects the electric pulse or the electric pulse sequence and resets the control unit.
